(19) United States
(12) Patent Application Publication
(10) Pub. No.: US 2026/0215608 A1
(43) Pub. Date: Jul. 30, 2026

(54) One-Handed Operation Serving Spoon with Mechanism for Consistent Portion Control

(71) Applicant: Jordan Pierce Hidalgo, Belleair, FL (US)

(72) Inventor: Jordan Pierce Hidalgo, Belleair, FL (US)

(21) Appl. No.: 19/036,937

(22) Filed: Jan. 24, 2025

(51) Int. Cl. A47G 21/04; G01F 19/00

(52) U.S. Cl. CPC A47G 21/04; G01F 19/002

(57) ABSTRACT

The present invention relates to a one-handed operation serving utensil designed to provide precise and consistent portion control for food items. The utensil comprises a serving scoop of predefined capacity, an ergonomic handle, and a leveling mechanism operatively connected to the handle. The leveling mechanism, configured as either a gear-based or pivot-based sliding system, facilitates the removal of excess material from the serving scoop to ensure uniform servings. Upon actuation by pressing a section of the handle, the mechanism moves a slide, such as a flat blade, along the surface of the scoop to level its contents. The utensil is constructed from durable, food-safe materials and is modular to accommodate various portion sizes. This invention is particularly suited for food service environments requiring efficiency, precision, and repeatability, such as restaurants and catering services.

### BACKGROUND OF THE INVENTION

### Field of Invention

The present invention pertains to the field of culinary tools and utensils, specifically serving spoons designed to provide precise and consistent portion control of food items. More particularly, the invention relates to a one-handed operation serving spoon equipped with mechanisms for leveling and removing excess material to ensure a fixed, uniform serving size, suitable for applications in food service and preparation environments.

### Brief Summary of the Invention

The present invention introduces a one-handed operation serving spoon designed to provide precise and consistent portions of food, addressing the need for efficient and accurate portion control in food service settings. The invention features a leveling mechanism that removes excess material from the scoop, ensuring a uniform serving size with every use. Two embodiments are disclosed to achieve this functionality. In the first embodiment, a gear-based sliding mechanism utilizes a slide positioned above the serving spoon, which is operated through a wheel gear system integrated into the handle. By pressing the lower part of the handle, the gear rotates, causing the slide to move and level the contents of the scoop. In the second embodiment, a pivot-based sliding mechanism employs a pivot integrated into the handle to actuate the slide. Pressing the lower part of the handle activates the pivot, which facilitates the slide's motion over the scoop to remove excess material. Both designs are optimized for one-handed operation, making the invention particularly suitable for environments such as restaurants, where consistent portion control is essential.

### BRIEF DESCRIPTION OF THE FIGURES

FIG. 1 Depicts a profile representation of the one-handed operation serving utensil in its closed configuration, highlighting the lower handle (101), the wheel gear (102), the slide (103), and the serving scoop (104) in their resting positions.

FIG. 2 Illustrates a profile representation of the one-handed operation serving utensil with the leveling mechanism engaged, showing the lower handle (101) compressed, the wheel gear (102) rotated, the slide (103) extended, and the serving scoop (104) in use.

FIG. 3 illustrates the operational flow of the one-handed serving utensil, from scooping the food (FIG. 3.201) to dispensing a precise and leveled portion (FIG. 3.213), encompassing the activation and retraction of the leveling mechanism for consistent and efficient portion control.

### DETAILED DESCRIPTION

The present invention pertains to a serving utensil specifically designed for one-handed operation, providing an efficient and precise means of ensuring consistent portion control of food items. This utensil is particularly well-suited for food service environments where accuracy, speed, and repeatability are critical, such as in restaurant chains, catering services, and institutional kitchens. The invention features an innovative mechanism integrated into the handle of the utensil that facilitates the removal of excess food material from the serving scoop, ensuring that only a fixed and predetermined quantity of food is dispensed.

The invention comprises a serving spoon configured with a predefined capacity to hold a precise amount of food, such as three ounces, though alternative capacities may be adapted depending on specific use cases. The spoon is attached to an ergonomic handle designed to facilitate operation with a single hand. The handle incorporates a leveling mechanism that ensures consistency in the food portion dispensed. This leveling mechanism operates in one of two disclosed embodiments, each uniquely engineered to remove excess food material efficiently and effectively.

In the first embodiment, the leveling mechanism utilizes a gear-based sliding system. This system comprises a flat blade or slide situated parallel to or directly above the serving spoon. The slide is operably connected to a wheel gear mechanism housed within the handle. Upon pressing the lower section of the handle, the wheel gear is activated, causing the slide to move along the top surface of the serving spoon. This sliding motion levels the food by knocking off excess material above the predetermined capacity of the scoop. The gear-based system is designed to ensure smooth and reliable operation with minimal effort.

In the second embodiment, the leveling mechanism employs a pivot-based sliding system. In this configuration, the flat blade or slide is similarly positioned parallel to or above the spoon and is actuated by a pivot mechanism integrated into the handle. When the lower section of the handle is pressed, the pivot mechanism is engaged, causing the slide to traverse the surface of the scoop and remove any excess material. The pivot system is engineered to provide robust and repeatable performance while maintaining the utensil's ergonomic design.

Both embodiments are constructed to operate seamlessly with a single hand, enhancing the efficiency of food service operations. The mechanisms are fabricated from durable materials capable of withstanding the high-frequency use and rigorous cleaning processes common in commercial food service environments. The invention's modular design allows for the adaptation of the scoop and leveling components to accommodate various serving sizes, making it versatile for a wide range of applications.

The invention offers several advantages over conventional serving utensils. First, it ensures precise portion control by reliably removing excess material from the serving scoop, thereby promoting uniformity in food servings. Second, it enhances efficiency in food service operations by allowing users to serve accurate portions with one hand, freeing the other hand for concurrent tasks. Third, its robust construction and intuitive design reduce the likelihood of mechanical failure or operator error, ensuring long-term reliability.

This one-handed operation serving utensil is particularly beneficial in environments where consistent portion control is essential, such as fast-casual dining establishments, catering services, and institutional kitchens. For instance, in a restaurant setting, the utensil enables staff to serve a fixed amount of food, such as a precise portion of meat or rice, thereby maintaining consistency in customer servings while minimizing food waste. By integrating precision, efficiency, and durability, the present invention addresses a critical need in the food service industry, offering a substantial improvement over existing serving tools.

In a further embodiment, the invention includes a power-assisted or button-operated sliding mechanism to facilitate the movement of the leveling blade. This embodiment eliminates the need for a lower handle or pivot-based actuation, instead incorporating a slide button integrated directly into the main handle of the utensil. The slide button is designed to function similarly to the mechanism found in traditional flashlights, allowing the user to press and slide the button forward or backward to engage or disengage the leveling blade.

In this configuration, the slide button can be connected to internal gears, rails, or other mechanical systems that translate the sliding motion into the movement of the leveling blade across the serving scoop. The leveling blade remains parallel to or above the scoop, effectively removing excess material and ensuring the predetermined serving size is consistent with every use. Alternatively, in powered embodiments, the slide button may activate a motorized mechanism to drive the leveling blade, offering additional convenience in high-volume food service environments.

This embodiment also anticipates alternative designs, including a top-mounted handle that could move vertically or horizontally to actuate the leveling blade, or a trigger-pull mechanism integrated into the handle that facilitates blade movement. These variations are intended to encompass a wide range of possible methods for engaging the leveling mechanism, ensuring adaptability to user preferences and specific application requirements.

By including this button-operated or powered design, the invention broadens its scope to accommodate a variety of utility needs while maintaining the core functionality of consistent portion control, one-handed operation, and ergonomic ease of use. This embodiment, like the others, is designed for durable, high-frequency use in commercial food service environments and is adaptable to different serving sizes.

### DETAILED DESCRIPTION OF FIGURES

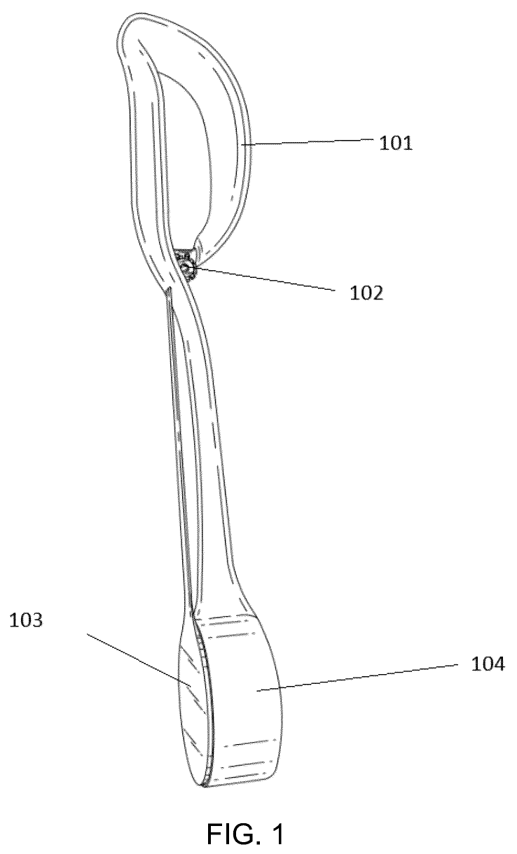

FIG. 1: shows the one-handed operation serving utensil in its inactive or closed state. The ergonomic lower handle (101) is illustrated, designed to enable a comfortable grip and easy one-handed operation. The wheel gear (102), integrated into the handle, is in its neutral position, not engaged. The slide (103), positioned above the handle and aligned with the top of the serving scoop (104), remains stationary in this configuration. The serving scoop (104) is depicted with its predefined capacity to hold a fixed amount of food. The closed configuration emphasizes the compactness and alignment of the components, ensuring the utensil is ready for use while preventing accidental activation.

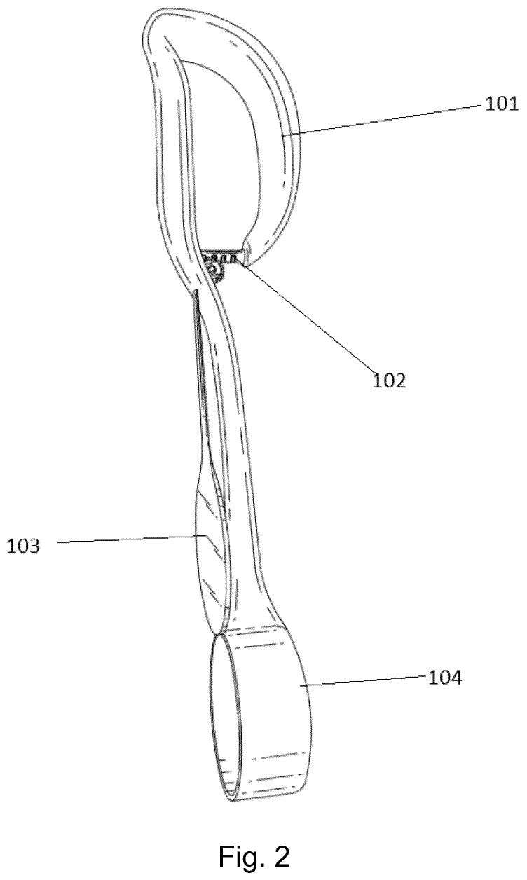

FIG. 2: depicts the one-handed operation serving utensil in its active or open state. The lower handle (101) is shown compressed, demonstrating how the user activates the leveling mechanism. This action rotates the wheel gear (102), which drives the motion of the slide (103). The slide (103) extends along the top surface of the serving scoop (104), illustrating its function of leveling or removing excess material to ensure a precise serving size. The serving scoop (104) remains stationary during this process, holding the fixed portion of food while the slide traverses its surface. This configuration highlights the dynamic interaction of the components during operation, ensuring consistent and efficient portion control.

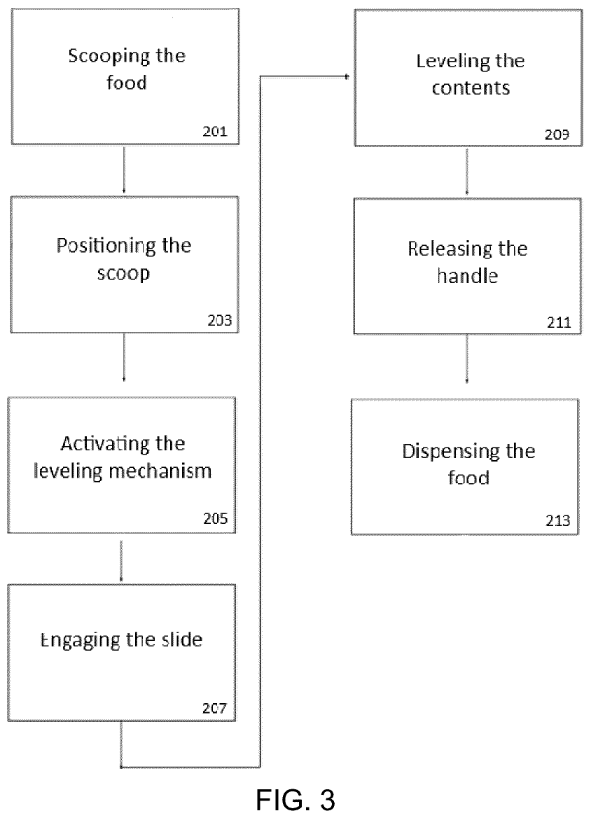

FIG. 3.201: Scooping the Food—The user begins by inserting the serving scoop into the desired food item, such as rice or meat. The scoop is designed to hold a predetermined amount of food, ensuring consistency in portion size. The ergonomic handle provides a firm grip for seamless operation.

FIG. 3.203: Positioning the Scoop—Once the scoop is filled, the user lifts the utensil and positions it at the desired angle, ensuring that the leveling mechanism aligns with the top surface of the food. The positioning facilitates a smooth leveling operation.

FIG. 3.205: Activating the Leveling Mechanism—The user presses the lower section of the handle, initiating the actuation of the leveling mechanism. Depending on the model, this action engages either the gear-based or pivot-based system to drive the slide into motion.

FIG. 3.207: Engaging the Slide—The leveling mechanism causes the slide, typically a flat blade, to move across the top surface of the scoop. This motion begins the process of removing any food exceeding the scoop's predefined capacity.

FIG. 3.209: Leveling the Contents—As the slide moves along the scoop's surface, it clears away excess material, ensuring that the remaining contents precisely match the intended portion size. The leveling motion is smooth and consistent to prevent disruption to the user.

FIG. 3.211: Releasing the Handle—After the slide completes its motion, the user releases the handle. The leveling mechanism retracts to its original position, ready for the next use. This retraction ensures seamless and repeatable operation.

FIG. 3.213: Dispensing the Food—The user dispenses the food from the scoop into the intended serving container. The leveled contents ensure a consistent portion size, maintaining precision and uniformity in food service.

What is claimed is:

1. A serving utensil for one-handed operation, comprising:
a. a serving scoop configured to hold a predetermined portion of food;
b. a handle ergonomically designed for one-handed use; and
c. a leveling mechanism operatively connected to the handle and positioned relative to the serving scoop, wherein the leveling mechanism is configured to remove excess material from the serving scoop to ensure a uniform portion size upon actuation.

2. The serving utensil of claim 1, wherein the leveling mechanism comprises:
a. a slide disposed above the serving scoop; and
b. a gear-based actuation system integrated into the handle, wherein pressing a section of the handle causes a wheel gear to rotate, thereby moving the slide along the surface of the serving scoop.

3. The serving utensil of claim 1, wherein the leveling mechanism comprises:
a. a slide disposed above the serving scoop; and
b. a pivot-based actuation system integrated into the handle, wherein pressing a section of the handle activates the pivot to facilitate movement of the slide along the surface of the serving scoop.

4. The serving utensil of claim 1, wherein the slide comprises a flat blade configured to traverse the surface of the serving scoop to remove any material exceeding the scoop's predetermined capacity.

5. The serving utensil of claim 1, wherein the serving scoop is configured to hold a fixed amount of food ranging from 1 ounce to 5 ounces.

6. The serving utensil of claim 1, wherein the handle and leveling mechanism are fabricated from materials resistant to wear, corrosion, and high-frequency use in food service environments.

7. The serving utensil of claim 2 or claim 3, wherein the actuation system is configured to return the leveling mechanism to its original position upon release of the handle.

8. The serving utensil of claim 1, wherein the utensil is modular, allowing for the serving scoop to be interchanged with scoops of varying sizes to accommodate different portion requirements.

9. The serving utensil of claim 1, further comprising a locking mechanism configured to secure the leveling mechanism in place when not in use.

10. The serving utensil of claim 1, wherein the utensil is configured for dishwasher-safe operation, with components designed to withstand temperatures and cleaning agents commonly used in commercial dishwashing systems.

11. The serving utensil of claim 1, wherein the leveling mechanism operates linearly or along a predefined path to ensure precise removal of excess material.

12. The serving utensil of claim 1, wherein the handle is designed with a textured or non-slip surface to enhance grip during operation.

13. A method of using a serving utensil, comprising:
a. scooping a portion of food with a serving scoop configured to hold a predetermined capacity;
b. activating a leveling mechanism operatively connected to a handle of the utensil by pressing a section of the handle; and
c. removing excess material from the scoop using a slide actuated by the leveling mechanism, thereby ensuring a uniform portion size.

14. The method of claim 13, wherein the leveling mechanism comprises a gear-based or pivot-based actuation system.

15. The method of claim 13, further comprising resetting the leveling mechanism to its original position upon release of the handle.
